(19) United States
(12) Patent Application Publication
(10) Pub. No.: US 2013/0260347 A1
(43) Pub. Date: Oct. 3, 2013

(54) SYSTEM AND METHOD FOR TEACHING A LANGUAGE

(71) Applicant: Joseph Sung Bin Im, Calgary (CA)

(72) Inventor: Joseph Sung Bin Im, Calgary (CA)

(21) Appl. No.: 13/438,519

(22) Filed: Apr. 3, 2012

(51) Int. Cl. G09B 19/00

(52) U.S. Cl. 434/167

(57) ABSTRACT

A method and apparatus for teaching grammar structure to a student. The apparatus comprises a representation of a human face a language base structure overlaid on the human face, a plurality of language patterns, each language pattern corresponding to one of a unique verb types selected from the group consisting of action verbs, linking verbs, general verbs, give and take verbs and cause and effect verbs and a pointer adapted to follow the language pattern. The method comprises identifying the verb and verb type to be used in the sentence, selecting a language pattern corresponding to the verb type, providing a representation of a human face having a language base structure thereon, overlaying the language pattern over the language base structure and beginning at a starting position of the language pattern, moving a pointer along the language pattern to determine a correct sequence of each word in the sentence.

### BACKGROUND OF THE DISCLOSURE

1. Field of Disclosure

The present disclosure relates to teaching language in general and in particular to a method and apparatus for teaching grammar patters in a language.

2. Description of Related Art

Learning a new language is a difficult activity for many people. A common way for many people to learn a new language is to take a course, read a book or follow recorded lessons on the new language. Typically, such methods teach the student many different words in that language with specific examples of how to combine these new words into sentences.

In general, classroom instruction and language textbooks design may further complicate task of teaching a new language. In most instances, the classroom is the setting used to directly teach a language whereas the textbook is used for home study. Thus, most language instruction require a high expenditure of the teacher's time and/or student practice.

One difficulty that exists with current methods of teaching a language is that although a student may be taught and learn a sufficient number of words in that language, the proper structure of the sentences for that language may be difficult for them. One reason for this is that different language have different sentence structures. Further difficulties are that within a given language, the sentence structure will differ depending upon the situation and words used within that sentence.

Previous attempts to teach students proper grammar structure have not been adequate. As set out above, previous attempts have been make to provide instructional videos or books providing a plurality of examples for the student. The difficulty of such methods is that it relies upon teaching the student a great number of examples of how to properly set out a grammatically correct sentence structure. Teaching of this many examples is time consuming and may also be prone to being limited to the examples themselves or close variations thereof.

Other attempts have been made to teach students the rules of grammar structure as rules that they need to apply to each situation. However attempting to teach students such rules which they must remember and apply to each sentence may cause more confusion for the students who are already struggling to remember the words of the new language and properly locate them in a sentence.

### SUMMARY OF THE DISCLOSURE

According to a first embodiment of the present disclosure there is disclosed an apparatus for teaching grammar structure to a student, the apparatus comprising a representation of a human face a language base structure overlaid on the human face, a plurality of language patterns, each language pattern corresponding to one of a unique verb types selected from the group consisting of action verbs, linking verbs, general verbs, give and take verbs and cause and effect verbs and a pointer adapted to follow the language pattern.

The language base structure may comprise an outer triangle overlaid on the human face having vertices at earlobes and a forehead of the human face. The language base structure may further include an inner triangle located therein having a first vertex at one of the earlobes of the human face and second and third vertices at midpoints of the sides of the first triangle extending from the first vertex.

According to a further embodiment of the present disclosure there is disclosed a method for teaching grammar structure in a sentence to a student, the method comprising the steps of Identifying the verb to be used in the sentence, determining the verb type as a type selected from the group consisting of action verbs, linking verbs, general verbs, give and take verbs and cause and effect verbs, selecting a language pattern corresponding to the verb type, providing a representation of a human face having a language base structure thereon, overlaying the language pattern over the language base structure and beginning at a starting position of the language pattern, moving a pointer along the language pattern to determine a correct sequence of each word in the sentence.

The language base structure may comprise an outer triangle overlaid on the human face having vertices at earlobes and a forehead of the human face. The language base structure may further include an inner triangle located therein having a first vertex at one of the earlobes of the human face and second and third vertices at midpoints of the sides of the first triangle extending from the first vertex.

Other aspects and features will become apparent to those ordinarily skilled in the art upon review of the following description of specific embodiments in conjunction with the accompanying figures.

### BRIEF DESCRIPTION OF THE DRAWINGS

In drawings which illustrate embodiments wherein similar characters of reference denote corresponding parts in each view,

FIG. 1 is an illustration of a representation of a face for use in a method for teaching grammar structure according to a first embodiment of the present invention.

FIG. 2 is an illustration of a representation of a face for use in a method for teaching grammar structure according to a first embodiment of the present invention.

FIG. 3 illustrates a language pattern for an action verb according to a first embodiment of the present invention.

FIG. 4 illustrates a language pattern for a linking verb according to a further embodiment of the present invention.

FIG. 5 illustrates a language pattern for a general verb according to a further embodiment of the present invention.

FIG. 6 illustrates a language pattern for a give and take verb according to a further embodiment of the present invention.

FIG. 7 illustrates a language pattern for an cause and effect verb according to a further embodiment of the present invention.

### DETAILED DESCRIPTION

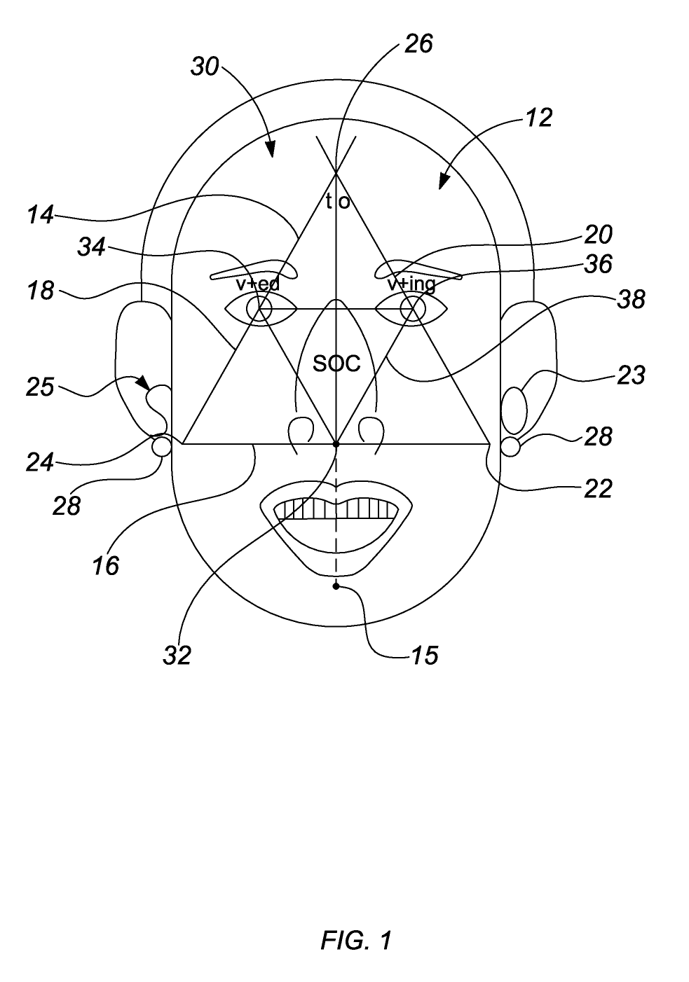

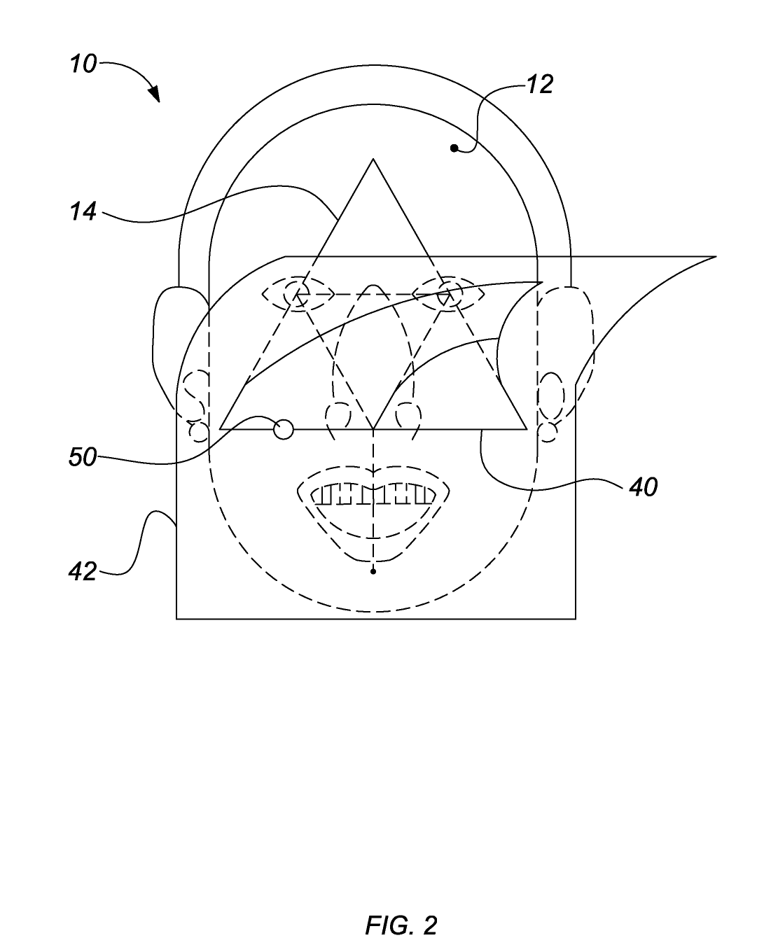

With reference to FIGS. 1 and 2, a system for teaching grammar structure according to a first embodiment of the present invention is disclosed. The system 10 comprises a representation of a face 12 having a base pattern, generally indicated at 14 thereon and at least one language pattern 40 applied thereto.

As illustrated in FIG. 1, the base pattern 14 comprises a triangle having first second and third sides, 16, 18 and 20, respectively extending between first second and third vertices, 22, 24 and 26, respectively. The first and second vertices 22 and 24 are located at the earlobes 28 of the face 12 while the third vertex is located at the forehead 30 of the face. As will be more fully described below, the second vertex 24 represents a subject conjunction verb clause while the line from the first midpoint 32 to the second vertex represents the subject of the sentence to be formed. The face 12 may therefore include an “s” associated with the ear proximate to the second vertex so as to provide a visual reference for a user of this designation. Similarly, the first vertex 22 represents an object conjunction verb clause while the line from the line from the first midpoint 32 to the first vertex 22 represents the object of the sentence to be formed. The face 12 may therefore include an “o” associated with the ear proximate to the first vertex so as to provide a visual reference for a user of this designation. The third vertex 26 represents the verb of the sentence and is located on the forehead 30 so as to provide a visual reference to a user that only a single verb is used in each sentence and is the primary controlling factor of the sentence. Each of the second and third midpoints, 34 and 36, represents an adjective for either a past tense verb or a present tense verb respectively. In particular, the second midpoint 34 represents a present participle while the third midpoint 36 represents a past participle. As set out above, a noun in each sentence is represented by a path beginning at the first midpoint 32 and extending to either the first or second vertices 22 or 24.

Each of the first, second and third sides 16, 18 and 20 has a corresponding midpoint, 32, 34 and 36, respectively. The base pattern also includes a fourth line, 38 extending between the first and third midpoints 32 and 36. The base pattern may also include an interjection 15 located below the mouth of the face.

In operation, a language pattern 40 is applied over the base pattern as illustrated in FIG. 2. The language pattern is of a type corresponding to the verb type that is used. In the present application, the verb of that sentence may be one of action verbs, linking verbs, general verbs, give and take verbs and cause and effect verbs. As described herein action verbs refer to those verbs which describe an action, such as, by way of non-limiting example, fly, go, walk, come or arrived. As described herein linking verbs refers to those verbs which link the subject with the complement of the sentence, such as, by way of non-limiting example, is, am, are, looks or sounds. As described herein general verbs refers to those verbs which describe a state of the mind of the subject, such as, by way of non-limiting example, love, like, knew, help or solve. As described herein give and take verbs refers to those verbs which denote a transfer of something from one party to another, such as, by way of non-limiting example, gave, teach, sent, awarded or offer. As described herein cause and effect verbs refer to those verbs which are incomplete transitive verbs which have object and complements, such as, by way of non-limiting example, made, creates, saw, have and declared.

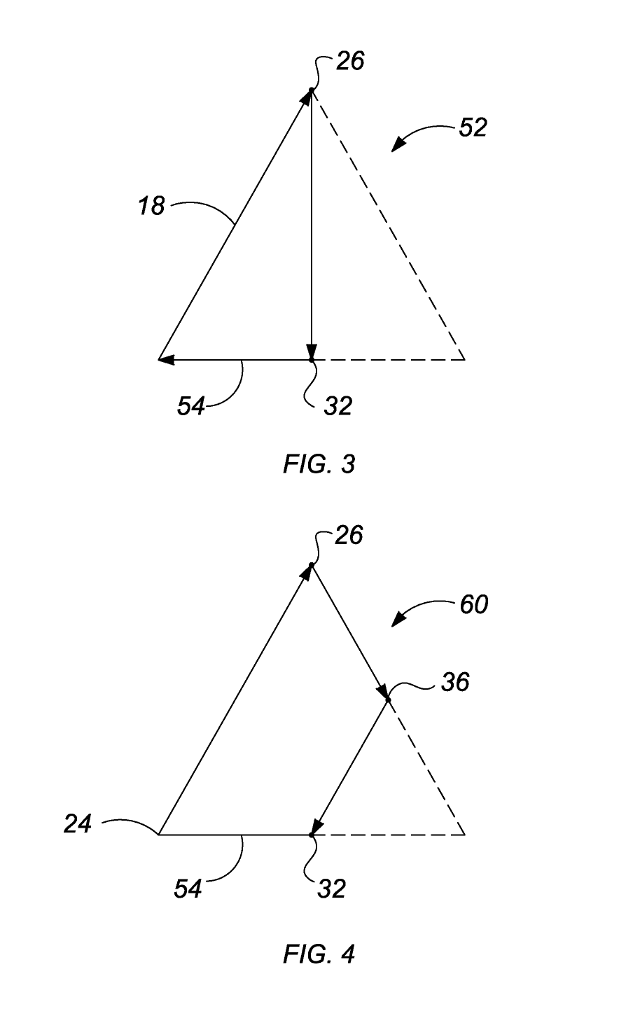

The language pattern 40 may be carried on a sheet of paper 42, transparent sheet or any other suitable substrate. As illustrated in FIG. 2, the language pattern is overlaid on the base pattern 14 so as to align the two patterns. Thereafter, a user may move a pointer 50, such as, by way of non-limiting example, a place marker, magnet or the like, along the path of the language pattern to determine the next appropriate word or word type in that sentence type. It will be appreciated that for any given sentence, the triangle shown in FIGS. 1 and 2 represents limitations on which types of words may possibly come next in the pattern. Further demonstration of the present principle will made with reference to the FIGS. 3 through 7 and below.

FIG. 3 shows a first language pattern 52 for an action verb. As illustrated the language pattern extends along a path beginning at the first midpoint. Such a sentence may be formed as “He came home”. The noun, “He”, in the sentence is represented by the line extending between the first midpoint 32 and the second vertex 24 generally indicated at 54. The verb, “came”, in the sentence is the next word and therefore the path now moves along the second side 18 to the third vertex 26. The final line in the pattern is to a noun, “home”, as represented by the line extending between the third vertex 26 and the first midpoint 32.

Turning now to FIG. 4, a second language pattern 60 for a liking verb is illustrated beginning at the first midpoint 32. Such a sentence may be formed as “I am a boy”. The first pronoun, “I” in the sentence is represented by the line extending between the first midpoint 32 and the second vertex 24 generally indicated at 54. The verb, “am”, in the sentence is the next word and therefore the path now moves along the second side 18 to the third vertex 26. The third line in this pattern extends from the third vertex 26 to the third midpoint 36 to represent an adjective, “a” and the fourth line in this pattern extends to the first midpoint 32 to represent the noun complement “boy”.

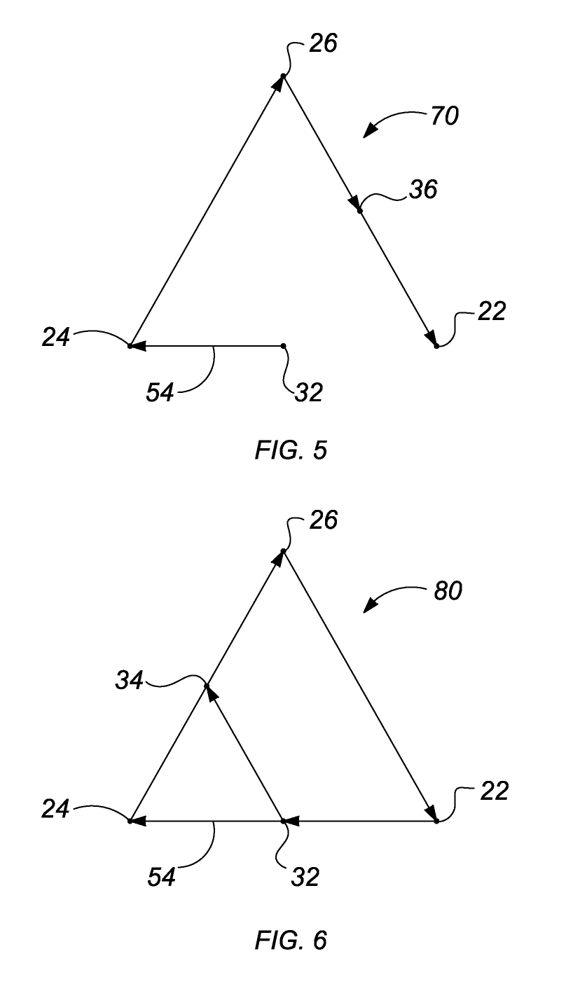

Turning now to FIG. 5, a third language pattern 70 for a general verb is illustrated beginning at the first midpoint 32. Such a sentence may be formed as “They knew the fact”. The first noun, “They” in the sentence is represented by the line extending between the first midpoint 32 and the second vertex 24 generally indicated at 54. The verb, “knew”, in the sentence is the next word and therefore the path now moves along the second side 18 to the third vertex 26. The third line in this pattern extends from the third vertex 26 to the third midpoint 36 to represent the adverb the and the final line extends to the first vertex 22 to represent the noun “fact”.

Turning now to FIG. 6, a third language pattern 80 for a give and take verb is illustrated beginning at the first midpoint 32. Such a sentence may be formed as “I gave him a book”. The first noun, “I” in the sentence is represented by the line extending between the first midpoint 32 and the second vertex 24 generally indicated at 54. The verb, “gave”, in the sentence is the next word and therefore the path now moves along the second side 18 to the third vertex 26. The third line in this pattern extends from the third vertex 26 to the first vertex 22 to represent a pronoun, “him” and the final line in this patter extends to the first midpoint 32 to represent a final noun “English”.

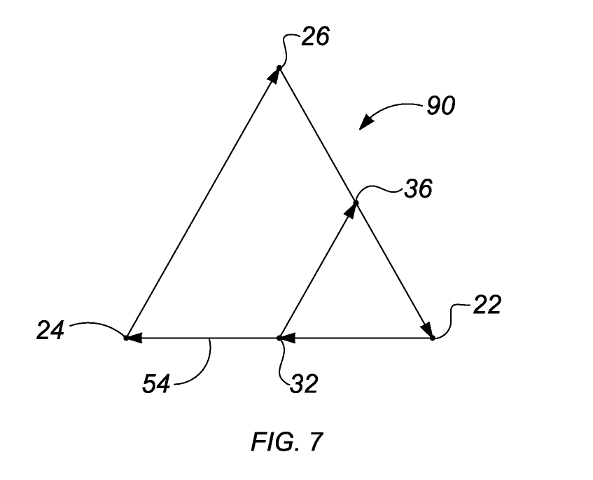

Turning now to FIG. 7, a third language pattern 90 for an cause and effect verb is illustrated beginning at the first midpoint 32. Such a sentence may be formed as “God creates all men equal”. The first noun, “God” in the sentence is represented by the line extending between the first midpoint 32 and the second vertex 24 generally indicated at 54. The verb, “creates”, in the sentence is the next word and therefore the path now moves along the second side 18 to the third vertex 26. The third line in this pattern extends from the third vertex 26 to the third midpoint 36 to represent the adjective, “all”. The fourth line in the pattern then extends to the first vertex 22 to represent the object noun “men” and the final line extends to the third midpoint 36 to represent the adjective “equal”.

While specific embodiments of the invention have been described and illustrated, such embodiments should be considered illustrative of the invention only and not as limiting the invention as construed in accordance with the accompanying claims.

What is claimed is:

1. An apparatus for teaching grammar structure to a student, the apparatus comprising:
a representation of a human face;
a language base structure overlaid on said human face;
a plurality of language patterns, each language pattern corresponding to one of a unique verb types selected from the group consisting of action verbs, linking verbs, general verbs, give and take verbs and cause and effect verbs; and
a pointer adapted to follow said language pattern.

2. The system of claim 1 wherein said language base structure comprises an outer triangle overlaid on said human face having vertices at earlobes and a forehead of said human face.

3. The system of claim 2 wherein said language base structure further includes an inner triangle located therein having a first vertex at one of said earlobes of said human face and second and third vertices at midpoints of the sides of said first triangle extending from said first vertex.

4. A method for teaching grammar structure in a sentence to a student, the method comprising the steps of:
Identifying the verb to be used in said sentence;
determining the verb type as a type selected from the group consisting of action verbs, linking verbs, general verbs, give and take verbs and cause and effect verbs;
selecting a language pattern corresponding to said verb type;
providing a representation of a human face having a language base structure thereon;
overlaying said language pattern over said language base structure; and
beginning at a starting position of said language pattern, moving a pointer along said language pattern to determine a correct sequence of each word in said sentence.

5. The method of claim 4 wherein said language base structure comprises an outer triangle overlaid on said human face having vertices at earlobes and a forehead of said human face.

6. The method of claim 5 wherein said language base structure further includes an inner triangle located therein having a first vertex at one of said earlobes of said human face and second and third vertices at midpoints of the sides of said first triangle extending from said first vertex.
